(19) United States
(12) Patent Application Publication
(10) Pub. No.: US 2024/0257615 A1
(43) Pub. Date: Aug. 1, 2024

(54) LOCATION-AWARE DIGITAL BETTING PLATFORM TRANSACTION PROCESSING SYSTEMS AND METHODS

(71) Applicant: BetSwap Limited, Douglas (IM)

(72) Inventors: Brent M. WINSTON, Toronto (CA); Joshua S. JACKSON, White Rock (CA)

(21) Appl. No.: 18/522,048

(22) Filed: Nov. 28, 2023

Related U.S. Application Data
(63) Continuation of application No. 17/739,305, filed on May 9, 2022, now abandoned.

(51) Int. Cl. G07F 17/32; G06Q 50/34

(52) U.S. Cl. CPC G07F 17/3288; G06Q 50/34; G07F 17/323; G07F 17/3239

(57) ABSTRACT

A location-aware digital betting transaction processing system and method are described, in which open bets involving gaming events are advertised for sale by ticket owners using a digital marketplace that is embedded in or electrically adjacent to a sportsbook platform (e.g., app or website). Ticket buyers and sellers provide their locations or their locations are automatically determined with their permission. Location information may be used by the marketplace and platform system(s) to determine and/or facilitate certain types of buy/sell transactions and for other purposes.

### CROSS REFERENCE TO RELATED APPLICATIONS

This application is a continuation of U.S. patent application Ser. No. 17/739,305, filed May 9, 2022, and published as U.S. Patent App. Pub. No. 2023/0360485 on Nov. 9, 2023, the disclosure of which is hereby incorporated by reference herein.

### BACKGROUND OF THE INVENTION

### Field of the Invention

The invention relates to betting using digital platforms. More specifically, the invention relates to digital betting platforms such as apps and websites and the processing of transactions of betting tickets between sellers and buyers using those platforms where the buyer's and seller's respective locations are taken into consideration as part of the execution and fulfillment of the transactions.

### Description of Related Art

In the digital betting industry, a sportsbook or bookmaker (or simply a book) is a person or establishment that processes customer bets (also known as wagers) involving sports (or sports-like) events and maintains an electronic ledger of those bets. Some companies that provide sportsbook services also provide daily fantasy sports (DFS) gameplay services for their customers. In the last decade, several states' legislatures have enacted laws permitting online betting and DFS, the result of which is an increase in the number of companies providing digital sportsbook and/or DFS platforms consisting of customer-facing (front end) apps and websites displayed on client devices (e.g., smartphones, tablets, laptops, desktop computers, etc.) with functionality that allows customers to place bets on various events (colloquially, this may be referred to as “online” betting) or participate in DFS gameplay.

In the non-digital world, a betting ticket is given to a customer who places a bet involving an event. A betting ticket may be considered a legal instrument recognized under contract law that contains a certificate from the ticket issuer to a person to whom it is issued (ticket holder) representing (or specifically mentioning) some right or privilege given by the ticket issuer to the ticket holder. In the digital sportsbook industry, when a customer places a bet, they are provided an electronic ticket, or a wagering ticket, which consists of a stored electronic record of the customer's bet made by the customer with respect to an event (e.g., a competitive game). The ticket represents a voucher given by the sportsbook to the customer representing the customer's right to collect winnings from the sportsbook if the customer wins the bet. Electronic tickets representing bets/wagers are stored electronically, such as in a database, and may be viewed by a customer on a sportsbook digital platform of their choice, such as the sportsbook's app or website. A unique electronic ticket may contain information such as the amount that was wagered by the customer when making the bet, the odds associated with the bet at the time of the wager, the price paid by the customer for the bet, and information about the nature of the bet (for example, the time that the event begins and ends).

A sports/sporting event may consist of individual parts that make up the event. By way of one example, a bet may involve the outcome of an entire season of a particular sports team, where the season includes intervening events such as individual games played by the team that make up the team's season. Another example of a bet may involve the outcome of a single event involving two or more individuals or sports teams that play each other (a “match” or “matchup”), where the event may be parsed into consecutive interposed times, periods, sets, frames, or other designated parts that make up the complete single event. By way of further example, a professional basketball game may be considered a single sporting event that consists of four interposed time periods between the start and the end of the game and that together make up the entirety of the played portion of the game. What is common among such events is that they have a defined beginning and an end that occurs in the future.

A betting customer may place several different bets with a sportsbook, either synchronously or asynchonously, and may place different kinds of bets, such as futures bets, halftime bets, in-game bets, and other kinds of bets. A popular form of betting involves futures betting, which, as the description above suggests, is generally a form of conditional probability in which a wager is made on the predicted future outcome of an event that has not begun based a set of known conditions. In other words, futures betting involves predicting future situations (e.g., the probability of an outcome or circumstance at the end of a defined event) based on present knowledge (e.g., the skill of individual players or teams, previous success or failure, weather forecasts, etc.).

One customer may make a plurality of bets using one or more sportsbooks, and they may hold in their personal account(s) multiple “open” tickets at any given time. An open ticket may be, for example, a futures bet that involves an event that has not started or ended. Open tickets may be said to be posted to the user's account by the digital platform the customer uses. For example, the platform may post to the customer's account a first ticket representing a bet or wager on a first event (e.g., a future game to be played), and may post to the customer's account a second ticket representing a different bet or wager on a second event (e.g., a future game to be played that is different than the other game). As noted, both the first and second tickets posted to the customer's account may be said to be open tickets until the commencement or completion of the respective first and second events.

In the case of DFS, customers participating in a given sporting event may hold one or more “teams” in their personal account(s) along with a ranking on a leaderboard for that customer (relative to other customers) if they are involved in a specific sport (e.g., sporting league). For example, a customer may possess in their account a first fantasy team consisting of “players” selected from real-world English Premier football league teams, the first team being characterized by its roster of players, its ranking among other customer's teams, and other information. The same customer may also possess in their account a second fantasy team consisting of “players” selected from real-world National Hockey League teams, the second team being characterized by its roster of players, its ranking among other customer's teams, and other information.

A customer's open tickets (including regular wagering tickets and those representing their position in a DFS event) may have a monetary value that changes over time, which may be computed by a sportsbook or DFS entity using various known mathematical techniques. Companies that provide betting and fantasy services need timely and accurate ticket valuations so they can set appropriate prices (e.g., cash-in or buy-back prices) when there is a market for the real-time buying and selling of open tickets among customers. U.S. Pat. No. 11,200,779 describes various examples for computing valuations and setting ticket prices, as well as some factors and general algorithms used to establish prices. In the case of DFS, the patent describes calculating valuations using a statistical expected value (EV) approach in which inputs include the jackpot value, price outcomes, and number of tickets that could still theoretically win a jackpot. Other techniques are also described.

Although popular, online betting and DFS have certain limitations and restrictions imposed on both customers and the companies that provide the sportsbook and DFS platforms, including the physical presence of a customer in the state in which they place bets. A customer using a digital platform to place their bets may need to be physically present in the state where that digital platform is permitted to operate by government regulators. But knowing the locations of customers, especially buyers and sellers of wagering tickets, may also be important for other reasons as well. For example, location, combined with other factors, may be used by a sportsbook company to assess betting behavior for predicting unhealthy betting habits; predicting and allocating system resources to address latency and routing issues; directing advertising resources; estimating sales, fees, and taxes to be paid; and other purposes. Physical location may be determined using customer-supplied address or other location information (stored in, for example a customer's stored profile), or geolocation information, which may be electronically generated by a customer's smartphone or an IP address of a computer they use to connect to an Internet gateway. Other location-aware technologies and techniques may also be used.

What is needed are devices, systems, and methods for transacting at least futures betting tickets and DFS standings between buyers and sellers where maintaining awareness of the buyer's and the seller's locations is important.

### BRIEF SUMMARY OF THE INVENTION

Described herein are exemplary devices, systems, and methods for transacting at least futures betting tickets between buyers and sellers of such tickets where maintaining awareness of the buyer's and the seller's locations is important.

In one aspect, the systems may include a digital sports betting platform having a defined marketplace portion that may be incorporated (embedded) into the platform where people can buy and sell futures bets like people trade other, non-sports wagers.

In another aspect, the digital marketplace may facilitate an in-kind exchange of futures bets between locations where different customers are located without actually transferring the rights in a uniquely identified ticket between those customers.

In still another aspect, the digital marketplace may be enabled to facilitate making a payoff to the ticket seller of a futures bet ticket at one location, generating a new futures bet ticket at a second location with the same potential payout reflected in the payed off first ticket, receiving a payment from a buyer of the new ticket, and transferring the payment from the buyer to the seller (or to the entity that made the payoff to the original ticket holder if a credit was given to the seller by the entity).

In another aspect, the digital platform, which may consist of the sportsbook platform with the marketplace, may be implemented in the cloud using data servers at each of the respective locations of the sportsbook entity and/or the marketplace entity and/or their customers.

Other aspects of the system include user, system, data security and privacy measures, and appropriate app and website look, feel, and functionality that digital product users typically expect.

In another aspect, a process is provided in which, with a click of a button, a customer may choose whether to sell or buy a futures bet ticket. The seller may control how much they sell their bet for, and buyers can browse the marketplace to find bets with odds that are no longer offered by a sportsbook and purchase those bet tickets.

In still another aspect, the system may use a price prediction algorithm to suggest a price at which a seller may sell a bet ticket to ensure that the value is maximized and the sale is quick. The system may display the better odds analysis to inform the buyer of the benefit they are receiving in purchasing each bet.

In another aspect, the system may use a different price prediction algorithm to suggest a price at which a seller may sell their DFS team(s) to ensure that the value for each team is maximized and the sale of each team is quick.

In still another aspect, once the software identifies that a listed bet ticket is sold, the bet may be transferred from the seller's “Open Bets” slip to the buyer's “Open Bets” slip. Additionally, the seller's cash balance may increase by the bet sale price and the buyer's cash balance will decrease by the bet purchase price. A bet may be resold an infinite number of times up until the outcomes of the underlying event(s) of the bet are determinable.

An advantage of the system as summarized above is that it provides benefits for both ticket buyers and sellers, and the sportsbook itself. Buyers can actively search for and purchase odds that are no longer available, rather than passively accept current odds offered by the sportsbook. Sellers can lock in guaranteed profits before the expiration of their bet ticket, in addition to relying on a cash-out.

Another advantage of the system is that the sportsbook and marketplace together may appear seamless from the perspective of the customer (buyer or seller) when they engage with the digital platform via the platform's app or website (though, while seamless, notice of location-aware transactions may be given to such customers, as applicable).

Another advantage of the system is its speed in delivering bet tickets and executing transactions when daily average users (DAU) and peak users (traffic) increase, such as during high demand betting situations like the Super Bowl® or March Madness® events. This may be accomplished, for example, by creating tickets in multiple locations based on existing tickets such that when a ticket, T1, at a first location, L1, goes up for sale, a substantially similar or identical ticket, T1′, at a second location, L2, may have already been generated, at least in part, and stored at the second location, L2, so that demand for the ticket, T1, may be immediately fulfilled by ticket, T1′, with minimal delay or disruption.

With those and other aspect, objects, advantages, and features of the invention that may become hereinafter apparent, the nature of the invention may be more clearly understood by reference to the following detailed description of the invention, the appended claims and to the several drawings attached herein.

### BRIEF DESCRIPTION OF THE DRAWINGS

FIGS. 1A and 1B are schematic diagram of a high-level representation of the components and information flow of an exemplary location-aware digital betting transaction processing system at a first location.

FIGS. 2A and 2B are schematic diagram of an exemplary base service for a location-aware digital betting transaction processing system.

FIG. 3 is a schematic diagram of a database entity relationship of a database for use with the location-aware digital betting transaction processing system.

FIGS. 4A-4C are schematic data and decision process flow diagrams illustrating certain aspects of a software component of the location-aware digital betting transaction processing system.

FIGS. 5A-5F are schematic sequence diagrams illustrating an exemplary sequence of steps and relationships between actors and components of a location-aware digital betting transaction processing system.

### DETAILED DESCRIPTION OF THE INVENTION

Several preferred embodiments of the invention are described for illustrative purposes, it being understood that the invention may be embodied in other forms not specifically shown in the drawings. The drawing figures herein are provided for exemplary purposes and are not drawn to scale. Specific details are described to provide an understanding of the inventive concepts; however, one of ordinary skill in the art will understand that the inventive concepts described here may be practiced without these specific details. In other instances, well-known features have been omitted or only briefly mentioned to avoid unnecessarily complicating the description.

The term “or” used here generally refers to an inclusive or and not an exclusive or. For example, a condition or list A or B is satisfied by any one of the following: A is true (or present) and B is false (or not present), A is false (or not present) and B is true (or present), and both A and B are true (or present). The term “a” or “an” are generally employed to describe elements and components of the embodiments herein for convenience of the reader and to give a general sense of the inventive concepts, and may be understood to include one, or at least one, the singular, and the plurality unless it is obvious that another meaning was intended.

A reference to “embodiments,” “implementations,” “configurations,” or “constructs” may refer to a particular element, feature, structure, or characteristic of the invention but does not mean the reference is to a single or the same embodiment or implementation. It is to be understood that the present invention may be implemented in various forms. For example, the invention may be embodied in hardware, software, firmware, special purpose computing devices, or a combination thereof centrally located or distributed, and operated or controlled by one person or entity or multiple people or entities. Throughout this description, the term “user” and “customer” generally refer to the same person, which is the person engaging with the customer-facing features of an app or website (where such features are provided).

The present invention may be implemented in software as a program tangibly embodied on a program storage device. The program may be uploaded to, and executed by, a machine comprising any suitable architecture, either centrally executed or executed on distributed devices networked to each other. Preferably, the machine executing the program is implemented on a computer having hardware including one or more central processing units (CPU); one or more memory devices, such as a random access memory (RAM); and one or more input/output (I/O) interface devices, such as peripheral device interfaces. The computer may also include an operating system and microinstruction code. The various processes and functions described herein may either be part of the microinstruction code or part of the program (or combination thereof) which is executed via the operating system. In addition, various other peripheral devices may be connected or networked to the computer such as additional data storage and printing devices, and various sensors, including biological, environmental, and/or other sensors for authenticating users.

It is to be further understood that, because some of the constituent system components and method steps depicted in the accompanying figures are preferably implemented in software, the actual connections between the system components (or the process steps) may differ depending upon the manner in which the present invention is programmed.

### System

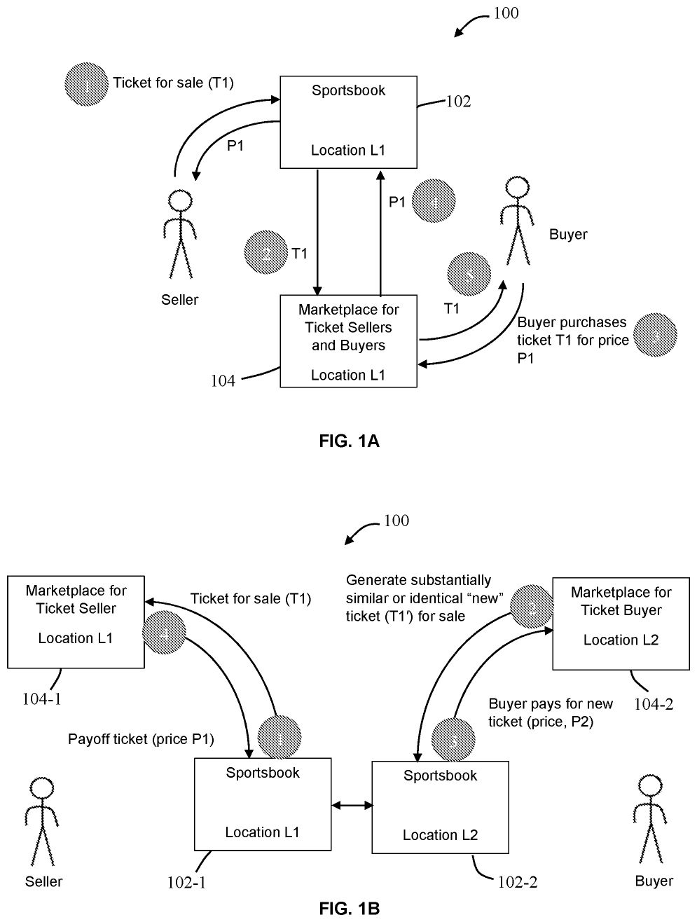

A description of the system aspects of the invention is first presented. With reference to FIG. 1A, shown therein is a schematic diagram of a high-level representation of the components and information flow of an exemplary location-aware digital betting transaction processing system 100 at a first location. Reference to a particular location does not mean that all the system 100 components are at or within a defined geographical location or area (e.g., a state, commonwealth, province, region, etc.). For example, a data server (not shown) of the system 100 may be in one physical location (e.g., British Columbia) while a web server (also not shown) may be in a different physical location (e.g., Quebec). In one aspect, location may be understood as referring to the system's functionality as being enabled to operate at or within a defined jurisdictional or other location or area, even though some of its components are in different jurisdictions.

In the configuration shown, a first networked (i.e., online) sportsbook platform 102, operating within a defined first location or area, includes or is in communication with a digital marketplace 104. When the sportsbook platform 102 is an app or website, the marketplace 104 may be an integral part of the app or website, made so by using various techniques known to those of ordinary skill in the art. For example, the code for generating the customer-facing front end (user interface (UI)/user experience (UX)) portion of the marketplace 104 may be provided to the sportsbook 102 system developers who incorporates it into code that generates the sportsbook 102 app or website. The code that provides the back-end portion of the marketplace 104 could similarly be provided to the system developers for incorporating into the sportsbook system. In this configuration, the sportsbook 102 and the marketplace 104 are seen as operating as a “single” seamless stack.

In another implementation, the marketplace 104 backend could be separate from the sportsbook 102 backend. When a customer's activity on the sportsbook's app or website requires the sportsbook 102 to communicate with the marketplace 104 backend, it makes a request via an application programming interface (API; see discussion below). In this configuration, the sportsbook 102 and the marketplace 104 are seen as operating their own different stacks.

In another implementation, the UI/UX portion of the marketplace 104 could be embedded in the sportsbook app or website using, for example, frame techniques programmed in, for example, extensible markup language (XML). In this kind of embedding, the frame-portion of the app/website requests and then receives content from the marketplace servers (not shown) to be displayed on the sportsbook 102 app or website separately from requests made to the sportsbook 102 backend. This creates the appearance, from the user's perspective, that the marketplace 104 is seamlessly part of the sportsbook 102 app or website. However, when the user interacts with the marketplace 104 portion of the app or website, data may be sent to the marketplace 104 backend rather than the sportsbook 102 backend for processing. Of course, in this configuration, the sportsbook 102 and the marketplace 104 also communicate information between them as necessary (and per pre-determined agreement) to provide a seamless experience for the user.

Still another implementation could involve the sportsbook 102 platform (back end and customer-facing front end) and the marketplace 104 (back end and customer-facing front end) being separate apps or websites, in which case the user is directed to one or the other depending on what activity they are performing or wish to perform. For example, the user might launch the sportsbook 102 app or website first, and then when they desire to conduct a marketplace transaction they could be directed to a separate app or website that launches on their client device (usually with permission of the user).

Implementations of the system 100 other than those described above are also contemplated.

With regard to the flow of information and data shown in FIG. 1A, and with reference to reference numbers 1-5, when a user at first location, L1, has acquired a betting ticket, T1, after placing a bet on the sportsbook 102 portion of system 100 (which is also at location L1), they may wish to sell that ticket. The user (depicted as “Seller” in the figure) is directed to the marketplace 104 portion of system 100 where T1 is displayed or otherwise made known to prospective purchasers. In this scenario, a purchaser (depicted as “Buyer” in the figure), who also is at L1, acquires T1 by paying an amount, P1, for T1. The amount P1 is transferred from the buyer's account to the seller's account on the sportsbook 102 via, for example, the marketplace 104.

Turning now to FIG. 1B, shown therein is a schematic diagram of a high-level representation of the components and information flow of a different exemplary location-aware digital betting transaction processing system 100. In the configuration shown, a first networked (i.e., online) sportsbook platform 102-1 is operating within a defined first location or area, L1, and includes or is in communication with a digital marketplace 104-1 as previously described. A second networked sportsbook platform 102-2 is operating within a defined second location or area, L2, and includes or is in communication with a second digital marketplace 104-2, as previously described. Alternatively, the sportsbook platforms 102-1 and 102-2 may be the same sportsbook platform that is accessible by many different users and from many different locations. Also, while only two platforms are shown in FIG. 1B, the configuration could include multiple networked sportsbook platforms, 102-1, 102-2, . . . , 102-n, and multiple marketplaces 104-1, 104-2, . . . , 104-n, where n represents the number of platforms and marketplaces, respectively. Alternatively, multiple individual sportsbook platforms 102-i (i≤n) may operate at a first location, while only one or a few platforms operates at a second location. Each sportsbook platform 102-1, 102-2, . . . , 102-n could be owned by the same entity or different entities operating in their respective geographical areas.

With regard to the flow of information and data shown in FIG. 1B, and with reference to reference numbers 1-4, in this particular implementation, a user at L1 has acquired a betting ticket, T1, after placing a bet on the sportsbook 102-1 portion of system 100 (which is also at L1) and wishes to sell that ticket. The user (“Seller”) is directed to the marketplace 104-1 portion of system 100, which is also at location L1, where T1 is displayed or otherwise made known to prospective purchasers. A purchaser (“Buyer”) at L2 wishes to acquire T1. Instead of paying an amount, P1, to purchase T1 directly and thus acquire T1, the sportsbook 102-1 or the marketplace 104-1 instead pays out the value of T1 to the seller, then the marketplace 104-2 generates a substantially similar or identical “new” ticket, T1′, for sale. The buyer then pays an amount, P2, for T1′. The amount P2 is transferred from the buyer's account to the seller's account (or to the sportsbook 102-1 or the marketplace 104-1 that previously paid P1 to the seller).

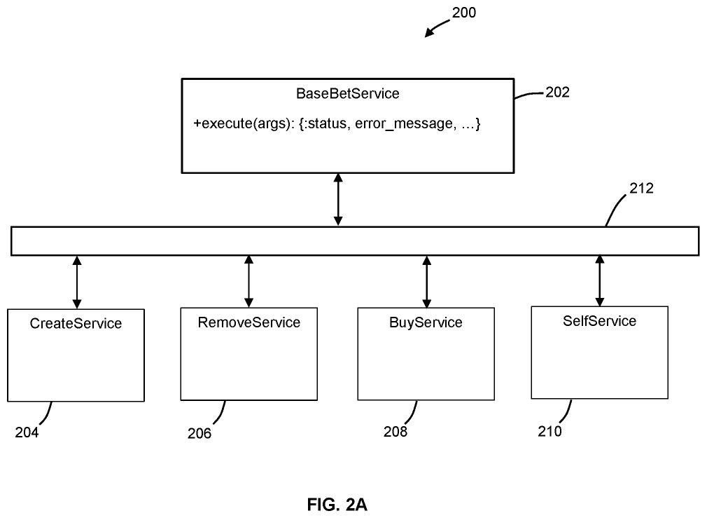

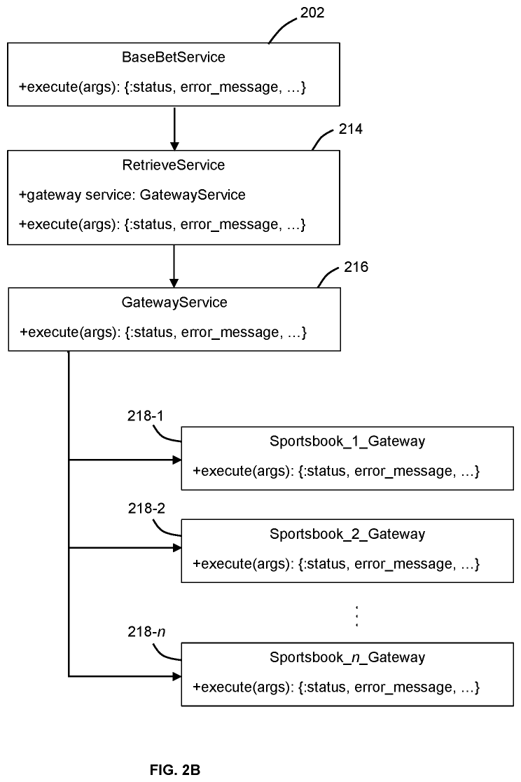

As noted above, the system 100 may be implemented and configured in different ways using various hardware and software stacks each with its own instruction set, some of which are now described. With reference to FIG. 2A, shown therein is an exemplary base betting service 200 for the location-aware digital betting transaction processing system 100. The base service 200 includes a base hardware/software stack 202 (“BaseBetService”) that may include one or more modules: a create service stack 204 (“CreateService”), a remote service stack 206 (“RemoteService”), a buy service stack 208 (“BuyService”), and a sell service stack (“SellService”) 210. Each stack may have its own hardware devices and software modules, including, as noted above, separate instruction sets, but of course some of individual service resources may be shared across services/stacks for optimization, cost efficiency, and other reasons. The base service 200 and its components may be configured to communicate information over an electronic communications bus or network 212 consisting of various signal communications elements known in the art.

Turning now to FIG. 2B, shown therein is an additional implementation of the exemplary base betting service 200 for a location-aware digital betting transaction processing system 100 shown in FIG. 2A. In this figure, the base hardware/software stack 202 (“BaseBetService”) is in communication with a retrieve service stack 214 (“RetrieveService”). The retrieve service stack 214 is in communication with and interoperable with a gateway service stack 216, which provides gateway access to the various sportsbook platforms 102-1, 102-2, . . . , 102-n via associated sportsbook gateways 218-1, 218-2, . . . , 218-n, respectively. The retrieve service stack 214 uses the gateway service stack 216 to ensure it is returning and accessing correct information from the base services stack 202. The various sportsbooks 102-1, 102-2, . . . , 102-n may use a common or different application programming interface (API) protocols each with their own unique sportsbook IDs (see below) when they are not part of one large group of services but rather are individual platforms.

### Storage

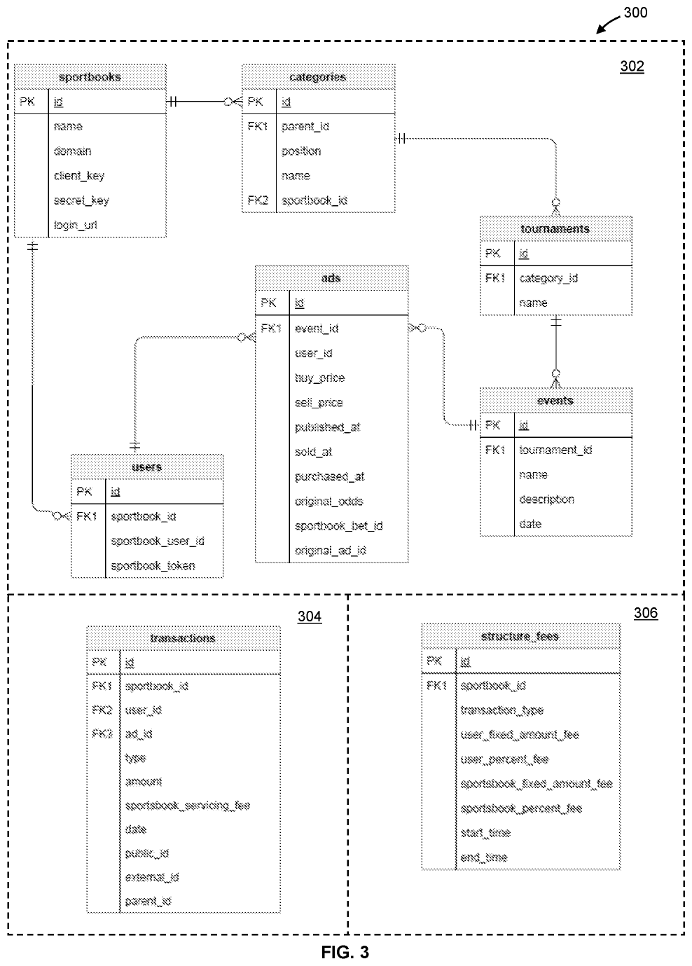

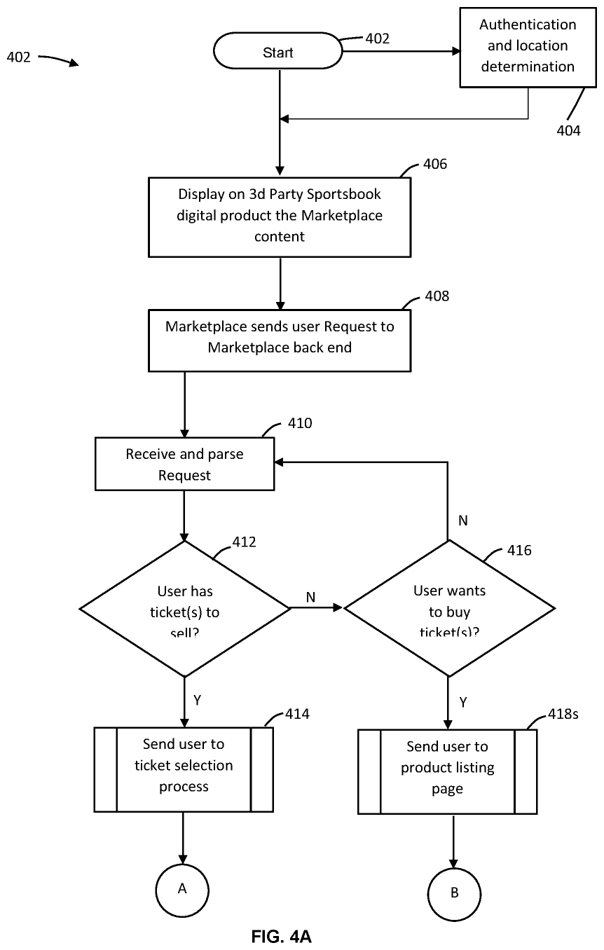

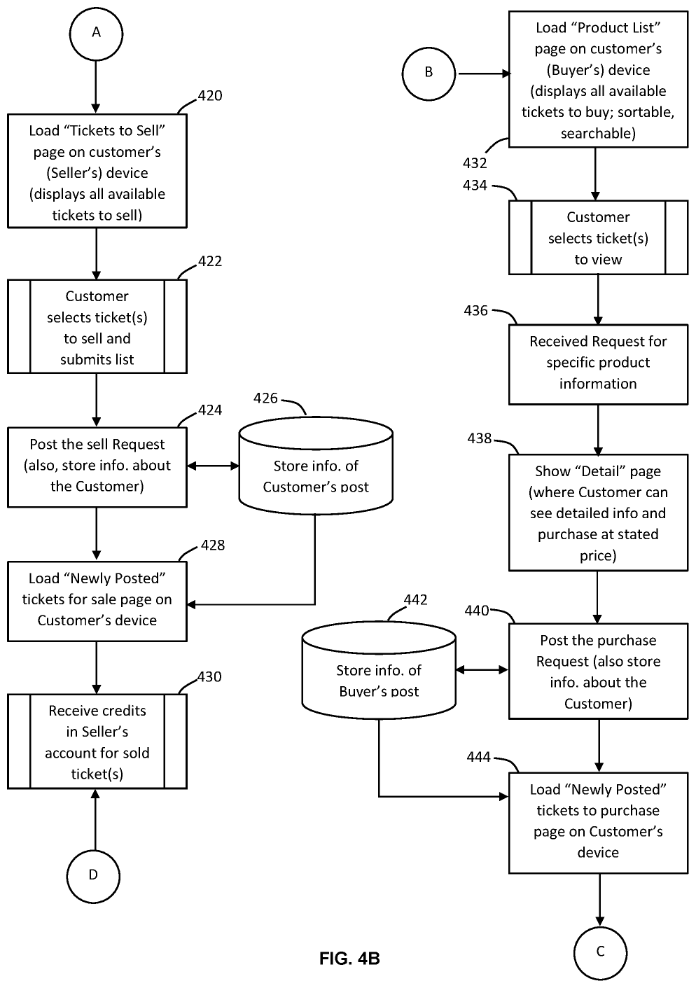

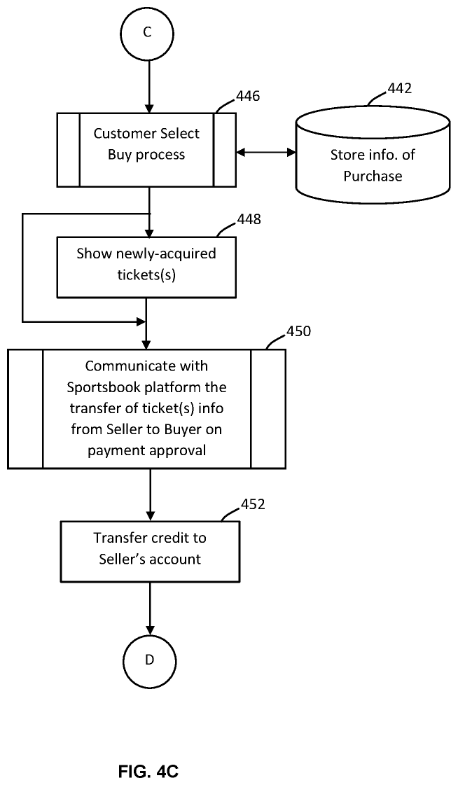

An enterprise data storage construct for the system 100 may include one or more electronic data repositories, such as a database, a knowledgebase, a graph, and others. By way of a non-limiting example, FIG. 3 is an exemplary database entity relationship diagram of a database 300 for use with the system 100. The database 300 may be an SQL database, which is embodied in a physical data storage device (as shown in FIG. 4A et seq., described below) such as a solid state drive or digital memory device. In the general implementation shown, the database 300 may consist of three SQL databases 302, 304, 306, but those skilled in the art will appreciate that other database hierarchies (parent-child tables), relationships, and mappings may be used depending on how one wishes to read data into and out of their specific database.

The database 302 may include a “Sportsbook” parent table, which itself may include a parent key “ID” and table fields “name,” “domain,” “client_key,” “secret_key,” and “login_url.” This table may be used, for example, to store information related to those fields, such as a customer's access (login), authentication, and use activities on one of the digital platforms previously described. Other fields could also be included in the “Sportsbook” parent table.

The “Sportsbook” parent table may include the following child tables in descending relationship: “Sportsbook”→“Users”→“Ads” in one branch, and “Sportsbook”→“Categories”→“Tournaments”→“Events”→“Ads” in a separate branch. One of ordinary skill will appreciate that other table names may be used, and additional or fewer table fields may be included in each child table.

The “Users” child table may be indexed to the parent key “ID” in the “Sportsbook” parent table. Its table fields may include “sportsbook_id,” “sportsbook_user_id,” and “sportsbook_token”, where the “sportsbook_id” field may be a foreign key (FK) that is indexed (mapped) to another table in one of the databases 302, 304, 306 or a different database. Other fields could also be included in the “Users” child table.

The “Ads” child table may be indexed to the parent key “ID” in the “Sportsbook” parent table. Its table fields may include “event_id,” “user_id,” “buy_price,” “sell_price,” “published_at,” “sold_at,” “purchased_at,” “original_odds,” “sportsbook_bet_id,” and “original_ad_id,” where the “event_id” field may be an FK that is indexed to another table. Other fields could also be included in the “Ads” child table. For purpose of this description, a ticket selected by a customer to be sold on that customer's displayed marketplace 104-i will be referred to as an “ad” (“ads,” the plural form, refers to more than one ticket for sale). Thus, as shown in the “Ads” table, information about each ticket ad will include an identification of the event the ticket relates to, an identification of the customer (user), they buy price, the sell price, where the ticket is published “at,” where the ticket is sold “at,” where the ticket is purchased “at”, the original odds of the bet, an identification of the sportsbook where the bet ticket was generated, and other information. Here, “at” may refer to a virtual (i.e., digital platform app or website, and during a particular session once a user is logged on) and/or a geographical location.

The “Categories” table may also be indexed to the parent key “ID” in the “Sportsbook” parent table. Its table fields may include “parent_id,” “position,” “name,” and “sportsbook_id,” where the “parent_id” and the “sportsbook_id” fields may be an FK that is indexed to other tables. Other fields could also be included in the “Categories” child table.

The “Tournaments” table may also be indexed to the parent key “ID” in the “Sportsbook” parent table. Its table fields may include “category_id” and “name.” Other fields could also be included in the “Tournaments” child table.

The “Events” table may also be indexed to the parent key “ID” in the “Sportsbook” parent table. Its table fields may include “tournament_id,” “name,” “description,” and “date.” Other fields could also be included in the “Events” child table.

The database 304 may include a “Transactions” parent table, which may include the parent key “ID” and table fields “sportsbook_id,” “user_id,” “ad_id,” “type,” “amount,” “sportsbook_servicing_fee,” “date,” “public_id,” “external_id,” and “parent_id.” Other fields could also be included in the “Transactions” parent table.

The database 306 may include a “Structure_Fees” parent table, which may include the parent key “ID” and table fields “sportsbook_id,” “transaction_type,” “user_fixed_amount_fee,” “user_percent_fee,” “sportsbook_fixed_amount_fee,” “sportsbook_percent_fee,” “start_time,” and “end_time.” Other fields could also be included in the “Structure_Fees” parent table.

From the above, it will be apparent the kinds of data that the system 100 may collect and process about a customer's activity and engagement with the system 100 so that the system 100 may process the betting ticket buy/sell transactions previously described. For example, a ticket T1 may be stored as a defined set of information including the “sportsbook_id,” which may identify which sportsbook platform 102-1, 102-2, . . . , 102-n the customer is using; the “tournament_id” “name,” “description,” and “date,” which may identify the event the customer has bet on and for which they received the ticket T1; and the “original_odds,” which may identify the odds given to the customer associated with the event when they placed the bet.

Also from the above, it will be apparent how to construct an API data pipeline protocol that may be needed to communicate data between components of the system 100. For example, a suitable API may identify the parameters associated with each of the above table fields so that a request to sell the ticket T1 may be properly handled by a receiving back end component.

In one configuration and use, all of the databases 302, 304, 306 may be centrally located at a single location or multiple locations in a defined area. In another configuration and use, each of the databases 302, 304, 306 may be distributed and placed in remote locations with respect to one another (e.g., physically located in different data centers in different cities, states, and countries) to address latency, cost, regulatory, and other issues. Duplicate or backup databases may also be used.

### Software

Next, the software functionality of the system 100 will be described with reference to exemplary non-limiting data and process flow diagrams. Turning first to FIG. 4A, shown therein is a high-level data and process flow diagram illustrating certain aspects of the software 400 of the system 100. The process begins generally at step 402.

At step 404, a login authentication step and a location-determination step may be performed. As noted above, there are multiple known techniques for identifying a customer's location (and safeguarding that data), any one or more of which may be used here. For example, a customer's location may be obtained from the geolocation data collected and stored by a smartphone. A customer's location may be obtained from an IP address of a computer the customer uses to connect to an Internet gateway, which connects the user to a universal resource locator (URL) associated with a website of the sportsbook platforms 102-i or the marketplace platforms 104-i. Moreover, a customer's location coordinates (x1, y1) may be compared to a database or knowledgebase containing information useful in determining the location of the customer relative to a pre-determined geographical boundary associated with those location coordinates. For example, a computation may be employed that performs a series of calculations of the linear map distance from the customer's location (x1, y1) to any one or more boundary position (x2, y2) on the geographical boundary until a minimum distance is found. Location information may be updated according to a pre-determined frequency.

At step 406, the system provides to a customer/user, after accessing their account on one of the sportsbook 102-i platforms, content including a navigation feature (e.g., menu). The app or website used by the customer receives an input from the customer that indicates that a ticket marketplace 104-i should be displayed on the app or website.

At step 408, a user's input is received along with other data about the ticket as described above.

At step 410, the software 400 parses the incoming request to identify specific components, which it may then store in one or more of the database tables as described above.

At step 412, the software 400 queries the parsed data to identify if the incoming request contains information indicating the customer wishes to sell the ticket, T. If the user has a ticket to sell, then the software 400 may execute a pre-defined process 414 involving sending the customer to a ticket selection page, which is shown on continuation FIG. 4B (connector “A”).

Otherwise, at step 416, the software 400 queries the parsed data to identify if the incoming request contains information indicating the customer wishes to buy the ticket, T. If the user wishes to buy the ticket, then the software 400 may execute a pre-defined process 418 involving sending the customer to a product listing page, which is shown on continuation FIG. 4B (connector “B”).

In FIG. 4B, with reference to connector “A,” this side of the transaction relates to customers who wish to sell their ticket T1 at location L1. At step 420, the software 400 causes the customer's marketplace 104-i to load a “Tickets to Sell” page on the app or website, which displays all available tickets the customer has acquired either by placing bets/wagers theirself or by otherwise acquiring tickets from others and who may offer to sell to others.

At step 422, the software 400 executes a pre-defined process that receives an input indicating that the customer has selected one or more tickets, T, to sell and generates a list of the selected tickets.

At step 424, the software 400 posts to the customer's account the request to sell the ticket(s) that the customer selected, and also stores information about the selection in a storage device 424, which may include all or some of the databases 302, 304, 306.

At step 426, the software 400 loads on a customer's “Newly Posted” tickets page the ticket(s) that they wish to sell.

At step 428, the software 400 load a “Newly Posted” tickets for sale page on the app or website displayed on the customer's client device.

At step 430, the software 400 executes a pre-defined process that receives credit(s) in the account of the customer for tickets that are “sold” (paid off by the platform 102-i and the marketplace 104-i that the customer used to sell their tickets).

With reference to the connector “B,” this side of the process flow relates to customers who wish to buy tickets T1′ at location L2. At step 432, the software 400 loads a “Product List” page on the customer's (buyer's) app or website displayed on the customer's client device. The Product List page may display a sortable and searchable list of all available tickets from all Sellers that the customer may buy.

At step 434, the software 400 executes a pre-defined process whereby the customer selects individual ticket(s) to view.

At step 436, the software 400 receives a Request for specific product (ticket) information about a selected ticket. The software 400 may obtain this information from the databases 302, 204, 306, or from other sources (for example, by sending an API request to a server provided by a sports league that contains real-time or near real-time event statistics).

At step 438, once responsive data is obtained from the databases 302, 304, 306 or from the other sources, the software 400 loads a “Detail” page on the app or website displayed on the customer's client device. Once loaded, the customer can see detailed information about the ticket and purchase it at the stated price.

At step 440, the software 400 posts to the customer's account the purchase Request to buy the ticket(s) that the customer selected, and also stores information about the selection in a storage device 442, which may include all or some of the databases 302, 304, 306 or other databases.

At step 444, the software 400 loads a “Newly Posted Tickets to Purchase” page on the customer's client device. The process continues as shown in FIG. 4C (connector “C”).

In FIG. 4C, at step 446, the software 400 executes a pre-defined Customer Select Buy process whereby the purchase of the selected ticket(s) is executed. As described previously, this process involves a ticket that is substantially similar or identical to T1. This new ticket, T1′, is transacted.

At step 448, the software 400 displays newly-acquired tickets(s) to the buyer on their client device.

At step 450, the software 400 executes a pre-defined communication process whereby the sportsbook 102-i and marketplace 104-i used by the seller communicates with the sportsbook platform used by the seller the transfer of ticket(s) information from seller to buyer on payment approval.

At step 452, the software 400 receives information about the payment, P, from the seller and transfers a credit in the same amount to the seller's account (see connector “D” on FIG. 4B).

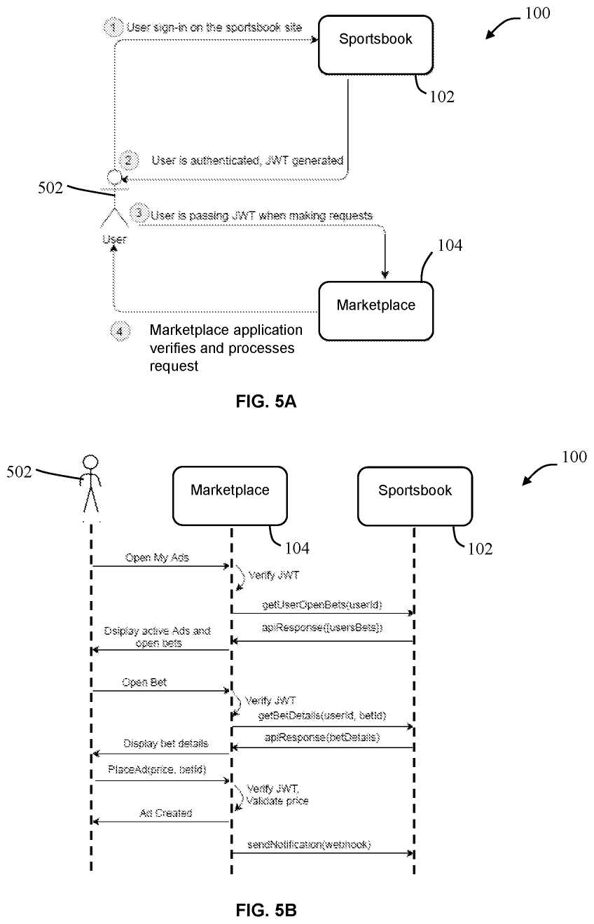

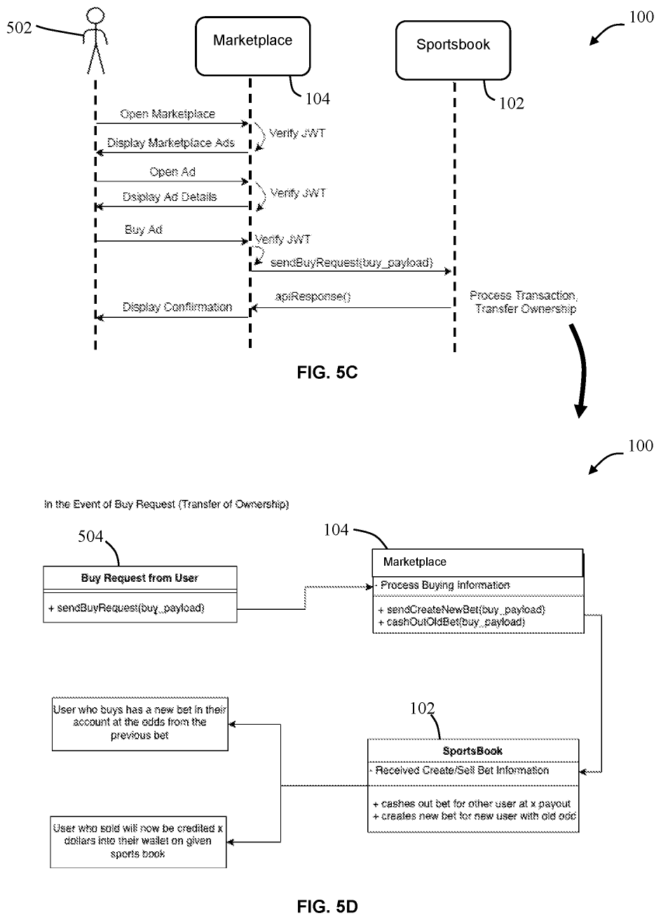

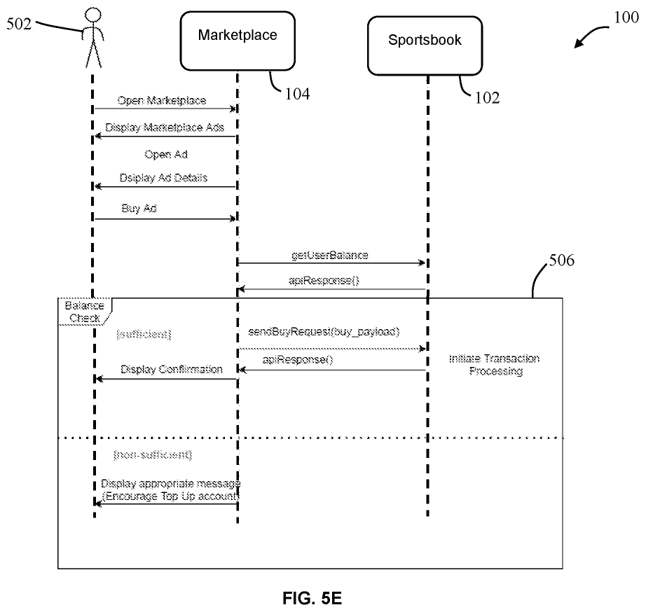

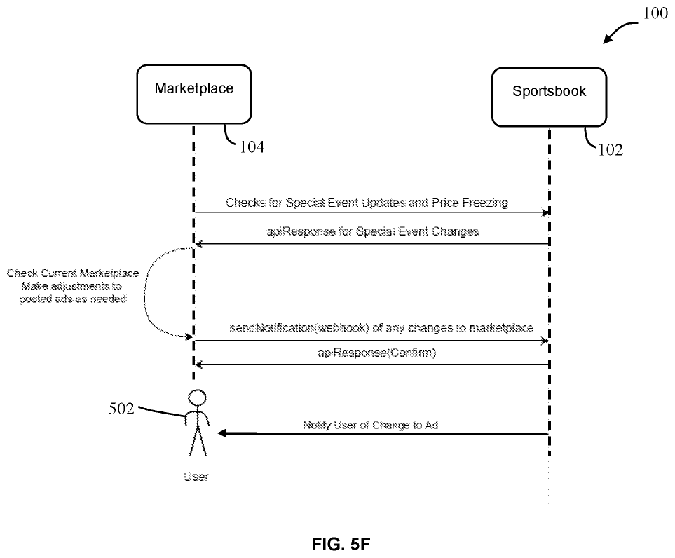

The following description will summarize how the invention works, with reference to FIGS. 5A through 5F, which are schematic sequence diagrams illustrating process relationships between a customer (users) 502 (specifically, the client device they are using, not shown), a specific marketplace 104 displayed on the client device, and a specific sportsbook 102 also displayed on the client device. As shown in FIG. 5A, a sequence may begin when a user 502 signs onto the sportsbook 102 website and is authenticated (here, a JSON web token (“JWT”) scheme is used). Once the user's identity is verified, the user navigates to the marketplace 104 by clicking a link or button displayed on the sportsbook 102 site which sends a request to the marketplace 104 back end. The user is verified by the marketplace 104 and their request is processed.

In FIG. 5B, the sequence involving a user placing a ticket up for sale on the marketplace 104 is shown (i.e., a sell session). First, the user may request to see their existing ticket ads. This request involves sending an API payload from the marketplace 104 to the sportsbook 102, which parses the payload, extracts the necessary information from the databases 302, 304, 306 (or some other information source) and returns a list of the user's open bets and any previous ticket ads they may have created on the sportsbook 102. The marketplace 104 then displays the user's active ticket ads and open ticket bets on the user's client device.

Second, the user may request to see the details of a particular open bet. This request involves sending an API payload from the marketplace 104 to the sportsbook 102, which parses the payload, extracts the necessary details from a databases or other information source, and returns the bet details. The marketplace 104 then displays the bet details on the user's client device.

Lastly, the user may wish to offer the open bet for sale on the marketplace 104. This involves creating an ad for the ticket using, as needed, the assistance of the pricing prediction algorithm. The open bet is converted to an ad with its associated price and displayed on the user's client device. Also, a notification of the conversion of the open bet that is being advertised for sale on the marketplace 104 is sent to the sportsbook 102.

Various pricing prediction algorithms may be used to suggest to the seller the price at which the advertised ticket may be offered to optimize (maximize) the value received by the seller and minimize the time it takes to sell the ticket. One such algorithm may consider a cash out value, a market value, and a true value for a particular betting ticket, and then use those value estimates to set a floor and an upper price range taking into consideration various margins to give the seller, the marketplace, and the sportsbook an amount in the transaction that is acceptable. For example, the pricing algorithm might set a price for a betting ticket at its cash out value plus an additional percent margin value. Thus, the algorithm might set a price equal to a cash out value plus an additional 0-100% of the cash out value, or plus an additional 5-75% of the cash out value, or plus an additional 10-30% of the cash out value, or some other margin amount, which may change over time as betting and other circumstances involving the marketplace and/or sportsbook change over time.

The pricing algorithm may instead (or in addition to) involve a process of predicting, using a machine learning decision model that has been trained using a data set containing information about previous advertised betting tickets (some of the features of this data set may include, for example, characteristics of the betting tickets sold, their prices, how much time it took to sell them, the geolocation of the seller when their client device received a request from them to convert an open ticket to an advertised ticket for sale, and the geolocation of the buyer when their client device received a request from them to buy the advertised ticket).

The pricing algorithm may instead (or in addition to) involve a process of using other prediction and classification techniques, such as linear and logistic regression, probability distribution tables, deep learning, support vector machines, nearest neighbor, Bayesian techniques, and/or decision trees, among others.

In the case of DFS transactions (e.g., the sale of a customer's team), a pricing algorithm may take into account the notion that at least one DFS customer must win at the conclusion of gameplay (unlike the case of standard betting where all customers except the house could lose). Thus, the pricing algorithm may consider the actual stakes that are at issue, which before an event or gameplay legs are actually played may be the same for each participating customer, and how the stakes may be paid out (e.g., tiered payouts). It is possible to also establish odds, which are fixed at the contest creation point based on predictions about participating customer's teams and certain variables used to assess current leaderboard standings (which may change as games or legs expire). At any given time during an event or gameplay, the variable affecting payout can be compared between customer-created tickets and the number of points potentially available to be won. Thus, pricing estimates for each customer's ticket could change based on leaderboard standings on the change of odds over time.

In FIG. 5C, the sequence involving a user purchasing an advertised open ticket on the marketplace 102 is shown (i.e., a buy session). First, after verifying the user and granting them access to the marketplace 104 app or website (or portion of the sportsbook 102 app or website in the case the marketplace 104 functionality is embedded and displayed in the sportsbook 102 app or website, as previously explained), the user may request to see available ticket ads. The marketplace 104 then locates and displays on the marketplace 104 displayed on user's client device all ticket ads that users have made available for sale.

Second, the user may click and open a particular ad; the marketplace responds by displaying the ad details.

Lastly, the user may buy the ad by clicking on a displayed link or button which sends a request. This request involves sending an API payload from the marketplace 104 to the sportsbook 102, which parses the payload and performs a “Process Transaction, Transfer Ownership” process (described below). Once that process is complete, the sportsbook 102 responds to the marketplace API request. The marketplace 104 then displays an ad buy confirmation on the user's client device.

In FIG. 5D, the “Process Transaction, Transfer Ownership” process is illustrated at a high level. First, with reference to the exemplary location-aware digital betting transaction processing system 100 confirmation shown in FIG. 1B (where the seller and buyer are at different locations L1 and L2, respectively), the request from the user to buy the advertised ticket, T1, and thus acquire T1, causes the marketplace 102 instead to cash out the T1 and generate a substantially similar or identical “new” ticket, T1′, for sale (a new ad).

Second, the marketplace 104 sends a payload to the sportsbook 102, which receives the create/sell information from the marketplace 104, cashes out the bet for the seller at a payout amount, P, creates the new bet, T1′.

Lastly, the buyer has a new bet ticket, T1′, in their account at the same odds from the original bet ticket, T1; and the seller is credited the amount, P, in a wallet account (as shown in FIG. 5E) at the sportsbook 102 they are using.

In FIG. 5E, a sequence involving checking whether the buyer has sufficient funds in their wallet account is illustrated. As described previously, once the buyer is verified and enters their marketplace 104 session, which displays all ticket ads that Sellers have made available for sale, the user selects an ad and is shown details about the ad on their client device. Once they make a buy request, the marketplace 104 sends an API payload to the sportsbook 102, which parses the payload and checks the buyer's account balance (sequence 506). If they have sufficient funds, the “Process Transaction, Transfer Ownership” sequence of FIG. 5D is executed. But if the buyer has insufficient funds, the marketplace 104 displays a message to the user that additional deposits to their wallet account are needed to buy the ad.

Finally, in FIG. 5F, a sequence involving making changes to existing ticket ads due to new circumstances is illustrated. First, the marketplace 104 checks for new circumstances by querying the sportsbook 102 using an API request (“new” circumstances may include, for example, a price freeze or an update involving a special event).

Second, the sportsbook 102 responds to the API request by pulling the requested information from the databases or other information sources, if any, and sending the information to the marketplace 104.

Third, the marketplace 104 receives the information and, if the information affects existing ticket ads for sale on the marketplace 104, the marketplace 104 may update the affected ticket ads.

Fourth, the marketplace 104 updates the sportsbook 102 of ticket ads that have been updated.

Lastly, the sportsbook 102 responds to the marketplace 104 with a confirmation and also sends a notification to all or some of its Buyers (e.g., email, text message, updated website content) who may have an interest in acquiring the updated ticket ads.

Although certain presently preferred embodiments of the disclosed invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

1-16. (canceled)

17. A method comprising:
retrieving, from a first database via an Application Programming Interface (“API”), information associated with a betting ticket associated with a first user, the information associated with the betting ticket including an identifier of an event, an identifier of the betting ticket associated with the event, an amount associated with the betting ticket, and original odds associated with the betting ticket associated with the event;
determining, using a suggested price algorithm, a current value for the betting ticket based on the amount associated with the betting ticket, current odds associated with the event, and the original odds associated with the betting ticket associated with the event;
causing display of the information associated with the betting ticket and the determined current value of the betting ticket;
receiving, from a second user that is different from the first user, a request for purchase of the betting ticket associated with the first user;
requesting generation, in response to the request for purchase of the betting ticket associated with the first user, and via an API, of a new betting ticket associated with the second user at the original odds associated with the betting ticket associated with the event; and
causing display, to the second user, of confirmation of the new betting ticket.

18. The method of claim 17, wherein receiving the information associated with the betting ticket comprises receiving an API payload with the information associated with the betting ticket from the first database.

19. The method of claim 17, wherein requesting generation of the new betting ticket associated with the second user at the original odds associated with the betting ticket associated with the event comprises sending an API payload with the request for purchase of the betting ticket associated with the first user to the first database.

20. The method of claim 17, wherein the suggested price algorithm is a machine learning decision model that has been trained using a data set comprising information associated with other betting tickets.

21. The method of claim 20, wherein the information associated with other betting tickets comprises at least one of prices of the other betting tickets and amounts of time to transfer the other betting tickets.

22. The method of claim 17, wherein the suggested price algorithm takes into consideration information associated with other betting tickets.

23. The method of claim 22, wherein the information associated with other betting tickets comprises at least one of available betting tickets associated with the event, number of betting tickets associated with the event, demand for betting tickets associated with the event, or amounts associated with betting tickets associated with the event.

24. The method of claim 17, wherein determining the current value for the betting ticket comprises determining a range between a floor value and an upper value of the betting ticket.

25. The method of claim 17, wherein determining the current value for the betting ticket is based on a cash out value of the betting ticket and a margin amount that is variable over time.

26. The method of claim 17, wherein the current value for the betting ticket is determined iteratively over time.

27. The method of claim 17, wherein, if the determination of the current value for the betting ticket is after a start of the event associated with the betting ticket, the information associated with the betting ticket includes real-time statistical information associated with the event.

28. The method of claim 17, further comprising:
receiving, from the first user, a request to sell the betting ticket,
wherein retrieving the information associated with the betting ticket is in response to reception of the request to purchase one or more betting tickets.

29. The method of claim 17, further comprising:
retrieving information associated with a plurality of betting tickets associated with the event; and
determining, using the suggested price algorithm, a current value for each of the plurality of betting tickets based on the amount associated with each of the plurality of betting tickets, current odds associated with the event, and the original odds associated with each of the plurality of betting tickets associated with the event.

30. The method of claim 29, wherein the information associated with the plurality of betting tickets associated with the event are received from a plurality of databases via a plurality of APIs.

31. The method of claim 17, wherein causing display of the information associated with the betting ticket and the determined current value of the betting ticket comprises causing display of a better odds analysis indicative of a benefit associated with purchasing the betting ticket.

32. The method of claim 17, further comprising authenticating the second user using a token.

33. A method comprising:
retrieving, from a first database via an Application Programming Interface (“API”), information associated with a betting ticket associated with an event that is no longer offered for purchase,
wherein the betting ticket is associated with a first user, and the information associated with the betting ticket includes an identifier of an event, an identifier of the betting ticket associated with the event, an amount associated with the betting ticket, and original odds associated with the betting ticket associated with the event;
determining, using a suggested price algorithm, a current value for the betting ticket based on the amount associated with the betting ticket, current odds associated with the event, and the original odds associated with the betting ticket associated with the event;
causing display of the information associated with the betting ticket and the determined current value of the betting ticket;
receiving, from a second user that is different from the first user, a request for purchase of the betting ticket associated with the first user; and
causing display, to the second user, of confirmation of the purchase of the betting ticket.

34. The method of claim 33, further comprising:
requesting generation, in response to the request for purchase of the betting ticket associated with the first user, and via an API, of a new betting ticket associated with the second user at the original odds associated with the betting ticket associated with the event,
wherein causing display of the confirmation of the purchase of the betting ticket comprises causing display of confirmation of the new betting ticket.

35. The method of claim 33, wherein the suggested price algorithm takes into consideration information associated with other betting tickets, and wherein the information associated with other betting tickets comprises at least one of available betting tickets associated with the event, number of betting tickets associated with the event, demand for betting tickets associated with the event, or amounts associated with betting tickets associated with the event.

36. The method of claim 33, wherein receiving the information associated with the betting ticket comprises receiving an API payload with the information associated with the betting ticket from the first database.
